(19) United States
(12) Patent Application Publication
(10) Pub. No.: US 2006/0094858 A1
(43) Pub. Date: May 4, 2006

(54) Novel copolyester compositions with improved impact strength at low temperatures

(76) Inventors: Sam Richard Turner, Kingsport, TN (US); Crystal Leigh Kendrick, Kingsport, TN (US)

Correspondence Address: B. J. Boshears;Eastman Chemical Company, P.O. Box 511, Kingsport, TN, 37662-5075, US

(21) Appl. No.: 10/975,141

(22) Filed: Oct. 28, 2004

(51) Int. Cl. C08G 63/02

(52) U.S. Cl. 528/272

(57) ABSTRACT

This invention relates to a polyester composition comprising: (i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid; and (ii) diol residues comprising from about 25 to about 70 mole percent, based on the total moles of diol residues, of the residues of 1,4-cyclohexanedimethanol, and from about 75 to about 30 mole percent, based on the total moles of diol residues, of the residues of 1,3-propanediol. This invention has surprising improved impact strength at low temperatures.

### FIELD OF THE INVENTION

The present invention relates to new copolyesters comprising a combination of 1,4-cyclohexanedimethanol (CHDM) and 1,3-propanediol (PD) with aromatic diacids.

### BACKGROUND OF INVENTION

Copolyesters based on terephthalic acid (TPA) with different ratios of CHDM and ethylene glycol are well known in the plastics marketplace. S. Richard Turner, Robert W. Seymour, John R. Dombroski, “Amorphous and Crystalline Polyesters Based on 1,4-Cyclohexanedimethanol” in “Modern Polyesters”, Chapter 7, Edited by J. Schiers and Timothy Long, John Wiley & Sons, (2003). Amorphous polyesters of terephthlatic acid, ethylene glycol and 1,3-propanediol are also described in J. W. Lee, S. W. Lee, B. Lee, and M. Ree, Macromol. Chem. Phys. p 202 (2001).

U.S. Pat. No. 6,482,484 describes poly(1,3-propanediol terephthalate), T(PD), which may be modified with small amounts, less than 10 mole percent, of polymer repeat units derived from copolymerized monomers so long as the crystallization behavior of the polyester is substantially the same as the homopolymer. U.S. Pat. No. 6,482,484 also describes a film layer comprising: poly(1,3-propanediol terephthalate) and a copolymer of 1,3-propanediol and up to about 20% by weight co-monomers, and particular nucleation promoters. The copolymers of T(PD) containing ethylene glycol and/or CHDM are described as being useful in making packaging materials.

It is generally known in the art that amorphous copolyesters possess a combination of desirable properties for many applications. These properties include excellent clarity and color, toughness, ease of processing, and chemical resistance. Accordingly, such copolyesters are useful for the manufacture of extruded sheet, packaging materials, and parts for medical devices, etc.

However, many applications require improvement in impact resistance at low temperature; thus, there is an unmet need in the polyester art for an amorphous copolyester with enhanced impact resistance, as measured by notched Izod impact values, at low temperatures.

### SUMMARY OF THE INVENTION

This invention relates to copolyester compositions comprising:
(i) diacid residues comprising at least 80 mole percent, preferably 90 mole percent, based on the total moles of diacid residues, of one or more residues of: terephthalic acid, naphthalenedicarboxylic acid, 1,4-cyclohexanedicarboxylic acid, or isophthalic acid; and
(ii) diol residues comprising about 25 to about 70 mole percent, preferably from about 30 to 70 mole percent, more preferably, from about 40 to about 60 mole percent, based on the total moles of diol residues, of the residues of 1,4-cyclohexanedimethanol, and from about 75 to about 30 mole percent, preferably from about 70 to about 30 mole percent, and more preferably, about 60 mole percent to 40 mole percent, based on the total moles of diol residues, of the residues of 1,3-propanediol.

A preferred embodiment is a copolyester composition comprising at least 80 mole percent, preferably at least 90 mole percent, and even more preferably, 100 mole percent of the residues of terephthalic acid, from about 40 to about 60 mole percent 1,4-cyclohexanedimethanol, preferably from about 45 to 55 mole percent, and from about 60 to about 40 mole percent 1,3-propanediol, preferably from about 55 to 45 mole percent.

Also preferred are one or more films or sheets prepared by extrusion or calendering of the copolyester compositions as described herein.

The compositions preferably are generally amorphous and have enhanced impact resistance, as measured by notched Izod impact values at low temperatures.

### DETAILED DESCRIPTION

This invention encompasses compositions comprising 1,3-propanediol, and/or CHDM and certain diacids.

More particularly, this invention provides a polyester composition comprising:
(a) a polyester, comprising
   (i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid;
   (ii) diol residues comprising about 25 to about 70 mole percent, preferably about 30 to about 70 mole percent, and more preferably about 40 to about 60 mole percent, based on the total moles of diol residues, of the residues of 1,4-cyclohexanedimethanol, about 75 to about 30 mole percent, preferably about 70 mole percent to about 30 mole percent, and more preferably, about 60 to about 40 mole percent, based on the total moles of diol residues, of the residues of 1,3-propanediol,
   wherein the total mole percentages of diacid residues in the polymer equals 100 mole percent and the total mole percentages of the diol residues in the polymer equals 100 mole percent; and wherein 0 to 45 mole percent of one or more diols selected from ethylene glycol, propylene glycol, 1,2-propanediol, 1,4-butanediol, 1,5-pentanediol, neopentyl glycol, diethylene glycol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol; and optionally,
   (iii) branching agents comprising about 0.01 to about 10 weight percent (wt %), preferably, 0.05 to about 5 weight percent (wt %), and even more preferably, 0.05 to about 1 weight percent (wt %), and even more preferably, based on the total weight of the polyester.

Surprisingly, the present invention provides a polyester composition with improved impact resistance at low temperatures. This improved impact strength or improved impact resistance is represented by notched Izod impact strength of greater 15 ft-lb/inch at 0° C. as measured according to ASTM D256 using ⅛ inch molded bars.

The copolyesters of the invention are preferably amorphous copolyesters. Amorphous copolyesters is generally defined as copolyesters that do not show a substantial melting point by differential scanning calorimetry when scanned at a rate of 20° C./min. Another way of defining the term “amorphous copolyester” is generally defined as a copolyester that has a crystallization half time from a molten state of at least 5 minutes. The crystallization half time may be, for example, at least 7 minutes, at least 10 minutes, at least 12 minutes, at least 20 minutes, and at least 30 minutes. The crystallization half time of the polyester, as used herein, may be measured using methods well-known to persons of skill in the art. For example, the crystallization half time may be measured using a Perkin-Elmer Model DSC-2 differential scanning calorimeter. The crystallization half time is measured from the molten state using the following procedure: a 15.0 mg sample of the polyester is sealed in an aluminum pan and heated to 290° C. at a rate of about 320° C./min for 2 minutes. The sample is then cooled immediately to the predetermined isothermal crystallization temperature at a rate of about 320° C./minute in the presence of helium. The isothermal crystallization temperature is the temperature between the glass transition temperature and the melting temperature that gives the highest rate of crystallization. The isothermal crystallization temperature is described, for example, in Elias, H. Macromolecules, Plenum Press: NY, 1977, p 391. The crystallization half time is determined as the time span from reaching the isothermal crystallization temperature to the point of a crystallization peak on the DSC curve.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.13, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The term “polyester”, as used herein, is intended to include “copolyesters” and is understood to mean a synthetic polymer prepared by the polycondensation of one or more difunctional carboxylic acids with one or more difunctional hydroxyl compounds. Typically the difunctional carboxylic acid is a dicarboxylic acid and the difunctional hydroxyl compound is a dihydric alcohol such as, for example, glycols and diols. The term “residue”, as used herein, means any organic structure incorporated into a polymer or plasticizer through a polycondensation reaction involving the corresponding monomer. The term “repeating unit”, as used herein, means an organic structure having a dicarboxylic acid residue and a diol residue bonded through a carbonyloxy group. Thus, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The polyester compositions of present invention are prepared from polyesters comprising dicarboxylic acid residues, diol residues, and optionally. branching monomer residues. The polyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a polyester containing 20 mole % isophthalic acid, based on the total acid residues, means the polyester contains 20 mole % isophthalic acid residues out of a total of 100 mole % acid residues. Thus, there are 20 moles of isophthalic acid residues among every 100 moles of acid residues. In another example, a polyester containing 30 mole % 1,4-cyclohexanedimethanol, based on the total diol residues, means the polyester contains 30 mole % 1,4-cyclohexanedimethanol residues out of a total of 100 mole % diol residues. Thus, there are 30 moles of 1,4-cyclohexanedimethanol residues among every 100 moles of diol residues.

The polyester compositions of the invention comprise polyesters that are amorphous which typically exhibit a glass transition temperature (abbreviated herein as “Tg”), as measured by well-known techniques such as, for example, differential scanning calorimetry (“DSC”).

The diacid residues of the polyester comprise at least 80 mole percent (mole %), based on the total moles of diacid residues, of one or more residues of terephthalic acid, naphthalenedicarboxylic acid, 1,4-cyclohexanedicarboxylic acid, or isophthalic acid. Any of the various isomers of naphthalenedicarboxylic acid or mixtures of isomers may be used, but the 1,4-, 1,5-, 2,6-, and 2,7-isomers are preferred. Cycloaliphatic dicarboxylic acids such as, for example, 1,4-cyclohexanedicarboxylic acid may be present at the pure cis or trans isomer or as a mixture of cis and trans isomers. For example, the polyester may comprise about 80 to about 100 mole % of diacid residues from terephthalic acid and 0 to about 20 mole % diacid residues from isophthalic acid.

The polyester also contains diol residues that may comprise about 25 to about 70 mole % of the residues of 1,4-cyclohexanedimethanol, 30 to about 70 mole % of the residues of 1,3-propanediol, and 0 to 45 mole % of one or more diols containing 2 to about 20 carbon atoms. As used herein, the term “diol” is synonymous with the term “glycol” and means any dihydric alcohol. For example, the diol residues also may comprise about 25 to about 70 mole percent, based on the total moles of diol residues, of the residues of 1,4-cyclohexanedimethanol and 30 to about 75 mole percent of the residues of one or more diols selected from ethylene glycol, 1,2-propanediol, 1,3-propanediol, 1,4-butanediol, 1,5-pentanediol, neopentyl glycol, diethylene glycol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol. Further examples of diols that may be used in the polyesters of our invention are triethylene glycol; polyethylene glycols; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,5-pentanediol; thiodiethanol; 1,2-cyclohexanedimethanol; 1,3-cyclohexanedimethanol; p-xylylenediol; bisphenol S; or combinations of one or more of these glycols. The cycloaliphatic diols, for example, 1,3- and 1,4-cyclohexanedimethanol, may be present as their pure cis or trans isomers or as a mixture of cis and trans isomers. In another example, the diol residues may comprise from about 25 to about 70 mole percent of the residues of 1,4-cyclohexanedimethanol, from about 30 to about 75 mole percent of the residues of 1,3-propanediol, and from about 0 to 45 mole percent of the residues of ethylene glycol. In a further example, the diol residues may comprise from about 40 to about 60 mole percent of the residues of 1,4-cyclohexanedimethanol, from about 60 to about 40 mole percent of the residues of 1,3-propanediol, and from about 0 to about 20 mole percent of the residues of ethylene glycol. In another example, the diol residues may comprise from about 55 to 45 mole percent of the residues of 1,4-cyclohexanedimethanol, from about 45 to 55 mole percent, and about 0 to 10 mole percent of the residues of ethylene glycol. In yet another example, the diol residues may comprise from about 45 to about 55 mole percent of the residues of 1,4-cyclohexanedimethanol, from about 55 to about 45 mole percent of the residues of 1,3-propanediol, wherein the residues of 1,4-cyclohexanedimethanol and 1,3-propanediol are the only diol residues present in the polyester, and the diacid residues comprise about 95 to about 100 mole percent of the residues of terephthalic acid. Residues of 1,4-cyclohexanedimethanol and 1,3-propanediol are preferably the only diol residues in the polyester.

The polyester also may further comprise from 0 to about 20 mole percent of the residues of one or more modifying diacids containing about 4 to about 40 carbon atoms. Examples of modifying dicarboxylic acids that may be used include aliphatic dicarboxylic acids, alicyclic dicarboxylic acids, aromatic dicarboxylic acids, or mixtures of two or more of these acids. Specific examples of modifying dicarboxylic acids include, but are not limited to, one or more of succinic acid, glutaric acid, adipic acid, suberic acid, sebacic acid, azelaic acid, dimer acid, or sulfoisophthalic acid. Additional examples of modifying diacarboxylic acids are fumaric; maleic; itaconic; 1,3-cyclohexanedicarboxylic; diglycolic; 2,5-norbornanedicarboxylic; phthalic; diphenic; 4,4′-oxydibenzoic; and 4,4′-sulfonyldibenzoic.

The polyester comprises from about 0.01 to about 10 weight percent (wt %), preferably, from about 0.05 to about 5 weight percent, and more preferably, from about 0.01 to 1 weight percent, based on the total weight of the polyester, of one or more residues of a branching monomer having 3 or more carboxyl substituents, hydroxyl substituents, or a combination thereof. Examples of branching monomers include, but are not limited to, multifunctional acids or glycols such as trimellitic acid, trimellitic anhydride, pyromellitic dianhydride, trimethylolpropane, glycerol, pentaerythritol, citric acid, tartaric acid, 3-hydroxyglutaric acid and the like. Preferably, the branching monomer residues comprise about 0.1 to about 0.7 mole percent of one or more residues of: trimellitic anhydride, pyromellitic dianhydride, glycerol, sorbitol, 1,2,6-hexanetriol, pentaerythritol, trimethylolethane, or trimesic acid. The branching monomer may be added to the polyester reaction mixture or blended with the polyester in the form of a concentrate as described, for example, in U.S. Pat. Nos. 5,654,347 and 5,696,176.

In a general embodiment, the polyester compositions of the invention are useful in making calendered film and/or sheet on calendering rolls. The polyester composition may also comprise one or more plasticizers to increase the flexibility and softness of calendered polyester film, improve the processing of the polyester, and help to prevent sticking of the polyester to the calender rolls. The invention also provides a process for film or sheet by calendering the novel polyester compositions and for the film or sheet produced from such calendering processes. The calendered film or sheet typically have a thickness in the range of about 2 mils (0.05 mm) to about 80 mils (2 mm).

While the inherent viscosity (I.V.) of the polyesters of the present invention is generally from about 0.4 to about 1.4 dL/g, other I.V.s are contemplated within the scope of this invention. The inherent viscosity refers to inherent viscosity determinations made at 25° C. using 0.25 gram of polymer per 50 mL of a solvent composed of 60 weight percent phenol and 40 weight percent tetrachloroethane. The basic method of determining the I.V. of the polyesters herein is set forth in ASTM method D2857-95. To obtain superior calendering line speeds, the polyesters of the present invention preferably have an inherent viscosity of about 0.55 to about 1.00 dL/g. Other examples of I.V. values which may be exhibited by the polyester compositions are about 0.55 to about 0.70 dL/g, about 0.55 to about 0.65 dL/g, and about 0.60 to about 0.65 dL/g.

In addition to the polyester, the polyester compositions described above may comprise an additive that is effective to prevent sticking of the polyester to the calendering rolls when the polyester is used to make calendered film. As used herein, the term “effective” means that the polyester passes freely between the calendering rolls without wrapping itself around the rolls or producing an excessive layer of polyester on the surface of the rolls. The amount of additive used in the polyester resin composition is typically about 0.1 to about 10 wt %, based on the total weight percent of the polyester composition. The optimum amount of additive used is determined by factors well known in the art and is dependent upon variations in equipment, material, process conditions, and film thickness. Additional examples of additive levels are about 0.1 to about 5 wt % and about 0.1 to about 2 wt %. Examples of additives of the present invention include fatty acid amides such as erucylamide and stearamide; metal salts of organic acids such as calcium stearate and zinc stearate; fatty acids such as stearic acid, oleic acid, and palmitic acid; fatty acid salts; fatty acid esters; hydrocarbon waxes such as paraffin wax, phosphoric acid esters, polyethylene waxes, and polypropylene waxes; chemically modified polyolefin waxes; ester waxes such as carnauba wax; glycerin esters such as glycerol mono- and di-stearates; talc; microcrystalline silica; and acrylic copolymers (for example, PARALOID® K175 available from Rohm & Haas). Typically, the additive comprises one or more of: erucylamide, stearamide, calcium stearate, zinc stearate, stearic acid, montanic acid, montanic acid esters, montanic acid salts, oleic acid, palmitic acid, paraffin wax, polyethylene waxes, polypropylene waxes, carnauba wax, glycerol monostearate, or glycerol distearate.

Another additive which may be used comprises a fatty acid or a salt of a fatty acid containing more than 18 carbon atoms and (ii) an ester wax comprising a fatty acid residue containing more than 18 carbon atoms and an alcohol residue containing from 2 to about 28 carbon atoms. The ratio of the fatty acid or salt of a fatty acid to the ester wax may be 1:1 or greater. In this embodiment, the combination of the fatty acid or fatty acid salt and an ester wax at the above ratio gives the additional benefit of providing a film or sheet with a haze value of less than 5%. The additives with fatty acid components containing 18 or less carbon atoms have a lower molecular weight and, thus, become miscible with the polyester. Such miscible additives have less interfacial migration surface qualities resulting in poor release or an increase in haze. In another example, the ratio of the fatty acid or salt of the fatty acid to the ester wax is 2:1 or greater.

The fatty acid may comprise montanic acid in which the salt of the fatty acid may comprise one or more of: the sodium salt of montanic acid, the calcium salt of montanic acid, or the lithium salt of montanic acid. The fatty acid residue of the ester wax may comprise montanic acid. The alcohol residue of the ester wax preferably contains 2 to 28 carbon atoms. Examples of alcohols include montanyl alcohol, ethylene glycol, butylene glycol, glycerol, and pentaerythritol. The additive may also comprise an ester wax which has been partially saponified with a base such as, for example, calcium hydroxide.

The polyesters of the instant invention are readily prepared from the appropriate dicarboxylic acids, esters, anhydrides, or salts, the appropriate diol or diol mixtures, and branching monomers using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. By “continuous” it is meant that the process is substantially or completely continuous in operation in contrast to a “batch” process. “Continuous” is not meant in any way to prohibit normal interruptions in the continuity of the process due to, for example, start-up, reactor maintenance, or scheduled shut down periods. The term “batch” process as used herein means a process wherein all the reactants are added to the reactor and then processed according to a predetermined course of reaction during which no material is fed or removed into the reactor. The term “semicontinuous” means a process where some of the reactants are charged at the beginning of the process and the remaining reactants are fed continuously as the reaction progresses. Alternatively, a semicontinuous process may also include a process similar to a batch process in which all the reactants are added at the beginning of the process except that one or more of the products are removed continuously as the reaction progresses. The process is operated advantageously as a continuous process for economic reasons and to produce superior coloration of the polymer as the polyester may deteriorate in appearance if allowed to reside in a reactor at an elevated temperature for too long a duration.

The polyesters of the present invention are prepared by procedures known to persons skilled in the art. The reaction of the diol, dicarboxylic acid, and branching monomer components may be carried out using conventional polyester polymerization conditions. For example, when preparing the polyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, about 150° C. to about 250° C. for about 0.5 to about 8 hours at pressures ranging from about 0.01 kPa gauge to about 414 kPa gauge (60 pounds per square inch, “psig”). Preferably, the temperature for the ester interchange reaction ranges from about 180° C. to about 230° C. for about 1 to about 4 hours while the preferred pressure ranges from about 103 kPa gauge (15 psig) to about 276 kPa gauge (40 psig). Thereafter, the reaction product is heated under higher temperatures and under reduced pressure to form the polyester with the elimination of diol, which is readily volatilized under these conditions and removed from the system. This second step, or poly-condensation step, is continued under higher vacuum and a temperature which generally ranges from about 230° C. to about 350° C., preferably about 250° C. to about 310° C. and, most preferably, about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ about 1.05 to about 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of polyester by direct esterification, i.e., from the acid form of the dicarboxylic acid component, polyesters are produced by reacting the dicarboxylic acid or a mixture of dicarboxylic acids with the diol component or a mixture of diol components and the branching monomer component. The reaction is conducted at a pressure of from about 7 kPa gauge (1 psig) to about 1379 kPa gauge (200 psig), preferably less than 689 kPa (100 psig) to produce a low molecular weight polyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

The copolyester compositions of the present invention may include any various additives conventional in the art. For example, the polyester blend can include from about 0.01 to about 50 weight percent, based on the total weight of the composition, of at least one additional additive selected from a lubricant, a non-polymeric plasticizer, a thermal stabilizer, an antioxidant, a pro-oxidant, an acid scavenger, an ultraviolet light stabilizer, a promoter of photodegradation, an antistatic agent, a pigment, a dye, and a colorant. Typical non-polymeric plasticizers include dioctyl adipate, phosphates, and diethyl phthalate. Representative inorganics include, talc, TiO2, CaCO3, NH4CL, and silica. Colorants can be monomeric, oligomeric, and polymeric. Preferred polymeric colorants are aliphatic polyesters, aliphatic-aromatic copolyesters, or aromatic polyesters in which the color producing monomer, i.e., a dye, is covalently incorporated into the polymer. Such representative polymeric colorants are described by Weaver et al. in U.S. Pat. Nos. 4,892,922, 4,892,923, 4,882,412,4,845,188, 4,826,903 and 4,749,773 the entire disclosures of which are incorporated herein by reference.

Although not essential, the polyester composition of the invention may comprise a plasticizer. The presence of the plasticizer is useful to enhance flexibility and the good mechanical properties of the calendered film or sheet. The plasticizer also helps to lower the processing temperature of the polyesters. The plasticizers typically comprise one or more aromatic rings. The preferred plasticizers are soluble in the polyester as indicated by dissolving a 5-mil (0.127 mm) thick film of the polyester to produce a clear solution at a temperature of 160° C. or less. More preferably, the plasticizers are soluble in the polyester as indicated by dissolving a 5-mil (0.127 mm) thick film of the polyester to produce a clear solution at a temperature of 150° C. or less. The solubility of the plasticizer in the polyester may be determined as follows:
1. Placing into a small vial a ½ inch section of a standard reference film, 5 mils (0.127 mm) in thickness and about equal to the width of the vial.
2. Adding the plasticizer to the vial until the film is covered completely.
3. Placing the vial with the film and plasticizer on a shelf to observe after one hour and again at 4 hours. Note the appearance of the film and liquid.
4. After the ambient observation, placing the vial in a heating block and allow the temperature to remain constant at 75° C. for one hour and observe the appearance of the film and liquid.
5. Repeating step 4 for each of the following temperatures (° C.): 100, 140, 150, and 160.

Examples of plasticizers potentially useful in the invention are as follows:

TABLE A
Plasticizers

Adipic Acid Derivatives
Dicapryl adipate
Di-(2-ethylhexyl adipate)
Di(n-heptyl, n-nonyl) adipate
Diisobutyl adipate
Diisodecyl adipate
Dinonyl adipate
Di-(tridecyl) adipate
Azelaic Acid Derivatives
Di-(2-ethylhexyl azelate)
Diisodecyl azelate
Diisoctyl azealate
Dimethyl azelate
Di-n-hexyl azelate
Benzoic Acid Derivatives
Diethylene glycol dibenzoate (DEGDB)
Dipropylene glycol dibenzoate
Propylene glycol dibenzoate
Polyethylene glycol 200 dibenzoate
Neopentyl glycol dibenzoate
Citric Acid Derivatives
Acetyl tri-n-butyl citrate
Acetyl triethyl citrate
Tri-n-Butyl citrate
Triethyl citrate
Dimer Acid Derivatives
Bis-(2-hydroxyethyl dimerate)
Epoxy Derivatives
Epoxidized linseed oil
Epoxidized soy bean oil
2-Ethylhexyl epoxytallate
Fumaric Acid Derivatives
Dibutyl fumarate
Glycerol Derivatives
Glycerol Tribenzoate
Glycerol triacetate
Glycerol diacetate monolaurate
Isobutyrate Derivative
2,2,4-Trimethyl-1,3-pentanediol,
Diisobutyrate
Texanol diisobutyrate
Isophthalic Acid Derivatives
Dimethyl isophthalate
Diphenyl isophthalate
Di-n-butylphthalate
Lauric Acid Derivatives
Methyl laurate
Linoleic Acid Derivative
Methyl linoleate, 75%
Maleic Acid Derivatives
Di-(2-ethylhexyl) maleate
Di-n-butyl maleate
Mellitates
Tricapryl trimellitate
Triisodecyl trimellitate
Tri-(n-octyl,n-decyl) trimellitate
Triisonyl trimellitate
Myristic Acid Derivatives
Isopropyl myristate
Oleic Acid Derivatives
Butyl oleate
Glycerol monooleate
Glycerol trioleate
Methyl oleate
n-Propyl oleate
Tetrahydrofurfuryl oleate
Palmitic Acid Derivatives
Isopropyl palmitate
Methyl palmitate
Paraffin Derivatives
Chloroparaffin, 41% C1
Chloroparaffin, 50% C1
Chloroparaffin, 60% C1
Chloroparaffin, 70% C1
Phosphoric Acid Derivatives
2-Ethylhexyl diphenyl phosphate
Isodecyl diphenyl phosphate
t-Butylphenyl diphenyl phosphate
Resorcinol bis(diphenyl phosphate) (RDP)
100% RDP
Blend of 75% RDP, 25% DEGDB (by wt)
Blend of 50% RDP, 50% DEGDB (by wt)
Blend of 25% RDP, 75% DEGDB (by wt)
Tri-butoxyethyl phosphate
Tributyl phosphate
Tricresyl phosphate
Triphenyl phosphate
Phthalic Acid Derivatives
Butyl benzyl phthalate
Texanol benzyl phthalate
Butyl octyl phthalate
Dicapryl phthalate
Dicyclohexyl phthalate
Di-(2-ethylhexyl) phthalate
Diethyl phthalate
Dihexyl phthalate
Diisobutyl phthalate
Diisodecyl phthalate
Diisoheptyl phthalate
Diisononyl phthalate
Diisooctyl phthalate
Dimethyl phthalate
Ditridecyl phthalate
Diundecyl phthalate
Ricinoleic Acid Derivatives
Butyl ricinoleate
Glycerol tri(acetyl) ricinlloeate
Methyl acetyl ricinlloeate
Methyl ricinlloeate
n-Butyl acetyl ricinlloeate
Propylene glycol ricinlloeate
Sebacic Acid Derivatives
Dibutyl sebacate
Di-(2-ethylhexyl) sebacate
Dimethyl sebacate
Stearic Acid Derivatives
Ethylene glycol monostearate
Glycerol monostearate
Isopropyl isostearate
Methyl stearate
n-Butyl stearate
Propylene glycol monostearate
Succinic Acid Derivatives
Diethyl succinate
Sulfonic Acid Derivatives
N-Ethyl o,p-toluenesulfonamide
o,p-toluenesulfonamide

A similar test to that above is described in The Technology of Plasticizers, by J. Kern Sears and Joseph R. Darby, published by Society of Plastic Engineers/Wiley and Sons, New York, 1982, pp 136-137. In this test, a grain of the polymer is placed in a drop of plasticizer on a heated microscope stage. If the polymer disappears, then it is solubilized. Plasticizers can also be classified according to their solubility parameter. The solubility parameter, or square root of the cohesive energy density, of a plasticizer can be calculated by the method described by Coleman et al., Polymer 31, 1187 (1990). The most preferred plasticizers will have a solubility parameter (δ) in the range of about 9.5 to about 13.0 cal^{0.5}cm^{-1.5}. It is generally understood that the solubility parameter of the plasticizer should be within 1.5 units of the solubility parameter of polyester. The plasticizers in Table B that are preferred in the context of this invention are as follows:

TABLE B
Preferred Plasticizers

Glycerol diacetate
monolaurate
Texanol diisobutyrate
Di-2-ethylhexyladipate
Trioctyltrimellitate
Di-2-ethylhexylphthalate
Texanol benzyl phthalate
Neopentyl glycol dibenzoate
Dipropylene glycol
dibenzoate
Butyl benzyl phthalate
Propylene glycol dibenzoate
Diethylene glycol dibenzoate
Glycerol tribenzoate

In the calendering process, higher molecular weight plasticizers are preferred to prevent smoking and loss of plasticizer during the calendering process. The preferred range of plasticizer content will depend on the properties of the base polyester and the plasticizer. In particular, as the Tg of the polyester as predicted by the well-known Fox equation (T. G. Fox, Bull. Am. Phys. Soc., 1, 123 (1956)) decreases, the amount of plasticizer needed to obtain a polyester composition that may be calendered satisfactorily also decreases. Typically, the plasticizer comprises from about 5 to about 50 weight percent (wt %) of the polyester composition based on the total weight of the polyester composition. Other examples of plasticizer levels are about 10 to about 40 wt %, about 15 to about 40 wt %, and about 15 to about 30 wt % of the polyester composition.

Examples of plasticizers which may be used according to the invention are esters comprising: (i) acid residues comprising one or more residues of: phthalic acid, adipic acid, trimellitic acid, benzoic acid, azelaic acid, terephthalic acid, isophthalic acid, butyric acid, glutaric acid, citric acid or phosphoric acid; and (ii) alcohol residues comprising one or more residues of an aliphatic, cycloaliphatic, or aromatic alcohol containing up to about 20 carbon atoms. Further, non-limiting examples of alcohol residues of the plasticizer include methanol, ethanol, propanol, isopropanol, butanol, isobutanol, stearyl alcohol, lauryl alcohol, phenol, benzyl alcohol, hydroquinone, catechol, resorcinol, ethylene glycol, neopentyl glycol, 1,4-cyclohexanedimethanol, and diethylene glycol. The plasticizer also may comprise one or more benzoates, phthalates, phosphates, or isophthalates. In another example, the plasticizer comprises diethylene glycol dibenzoate, abbreviated herein as “DEGDB”.

A flame retardant may be added to the polyester composition at a concentration of about 5 wt % to about 40 wt % based on the total weight of the polyester composition. Other examples of flame retardant levels are about 7 wt % to about 35 wt %, about 10 wt % to about 30 wt %, and about 10 wt % to about 25 wt %. Preferably, the flame retardant comprises one or more monoesters, diesters, or triesters of phosphoric acid. The phosphorus-containing flame retardant may also function as a plasticizer for the polyester. In another example, the plasticizer comprises diethylene glycol dibenzoate and the flame retardant comprises resorcinol bis(diphenyl phosphate). The flame retardant film or sheet will typically give a V2 or greater rating in a UL94 burn test. In addition, our flame retardant film or sheet typically gives a burn rate of 0 in the Federal Motor Vehicle Safety Standard 302 (typically referred to as FMVSS 302).

The phosphorus-containing flame retardant is preferably miscible with the polyester or the plasticized polyester. The term “miscible”, as used herein,” is understood to mean that the flame retardant and the plasticized polyester will mix together to form a stable mixture which will not separate into multiple phases under processing conditions or conditions of use. Thus, the term “miscible” is intended include both “soluble” mixtures, in which flame retardant and plasticized polyester form a true solution, and “compatible” mixtures, meaning that the mixture of flame retardant and plasticized polyester do not necessarily form a true solution but only a stable blend. Preferably, the phosphorus-containing compound is a non-halogenated, organic compound such as, for example, a phosphorus acid ester containing organic substituents. The flame retardant may comprise a wide range of phosphorus compounds well-known in the art such as, for example, phosphines, phosphites, phosphinites, phosphonites, phosphinates, phosphonates, phosphine oxides, and phosphates. Examples of phosphorus-containing flame retardants include tributyl phosphate, triethyl phosphate, tri-butoxyethyl phosphate, t-Butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthiono-phosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine.

The term “phosphorus acid” as used in describing the phosphorus-containing flame retardants of the invention include the mineral acids such as phosphoric acid, acids having direct carbon-to-phosphorus bonds such as the phosphonic and phosphinic acids, and partially esterified phosphorus acids which contain at least one remaining unesterified acid group such as the first and second degree esters of phosphoric acid and the like. Typical phosphorus acids that can be employed in the present invention include, but are not limited to: dibenzyl phosphoric acid, dibutyl phosphoric acid, di(2-ethylhexyl) phosphoric acid, diphenyl phosphoric acid, methyl phenyl phosphoric acid, phenyl benzyl phosphoric acid, hexylphosphonic acid, phenylphosphonic acid tolylphosphonic acid, benzyl phosphonic acid, 2-phenylethylphosphonic acid, methylhexylphosphinic acid, diphenylphosphinic acid, phenylnaphthylphosphinic acid, dibenzylphosphinic acid, methylphenylphosphinic acid, phenylphosphonous acid, tolylphosphonous acid, benzylphosphonous acid, butyl phosphoric acid, 2-ethyl hexyl phosphoric acid, phenyl phosphoric acid, cresyl phosphoric acid, benzyl phosphoric acid, phenyl phosphorous acid, cresyl phosphorous acid, benzyl phosphorous acid, diphenyl phosphorous acid, phenyl benzyl phosphorous acid, dibenzyl phosphorous acid, methyl phenyl phosphorous acid, phenyl phenylphosphonic acid, tolyl methylphosphonic acid, ethyl benzylphosphonic acid, methyl ethylphosphonous acid, methyl phenylphosphonous acid, and phenyl phenylphosphonous acid. The flame retardant typically comprises one or more monoesters, diesters, or triesters of phosphoric acid. In another example, the flame retardant comprises resorcinol bis(diphenyl phosphate), abbreviated herein as “RDP”.

Oxidative stabilizers also may be used with polyesters of the present invention to prevent oxidative degradation during processing of the molten or semi-molten material on the rolls. Such stabilizers include esters such as distearyl thiodipropionate or dilauryl thiodipropionate; phenolic stabilizers such as IRGANOX® 1010 available from Ciba-Geigy AG, ETHANOX® 330 available from Ethyl Corporation, and butylated hydroxytoluene; and phosphorus containing stabilizers such as IRGAFOS® available from Ciba-Geigy AG and WESTON® stabilizers available from GE Specialty Chemicals. These stabilizers may be used alone or in combinations.

It is also possible to use agents such as sulfoisophthalic acid to increase the melt strength of the polyester to a desirable level. In addition, the polyester compositions may contain dyes, pigments, fillers, matting agents, antiblocking agents, antistatic agents, blowing agents, chopped fibers, glass, impact modifiers, carbon black, talc, TiO₂ and the like as desired. Colorants, sometimes referred to as toners, may be added to impart a desired neutral hue and/or brightness to the polyester and the calendered product.

The various components of the polyester compositions such as, for example, the flame retardant, release additive, plasticizer, and toners, may be blended in batch, semicontinuous, or continuous processes. Small scale batches may be readily prepared in any high-intensity mixing devices well-known to those skilled in the art, such as Banbury mixers, batch mixers, ribbon blenders, roll mill, torque rheometer, a single screw extruder, or a twin screw extruder. The components also may be blended in solution in an appropriate solvent. The melt blending method includes blending the polyester, plasticizer, flame retardant, additive, and any additional non-polymerized components at a temperature sufficient to melt the polyester. The blend may be cooled and pelletized for further use or the melt blend can be calendered directly from this molten blend into film or sheet. The term “melt” as used herein includes, but is not limited to, merely softening the polyester. For melt mixing methods generally known in the polymer art, see “Mixing and Compounding of Polymers” (I. Manas-Zloczower & Z. Tadmor editors, Carl Hanser Verlag Publisher, 1994, New York, N.Y.). When colored sheet or film is desired, pigments or colorants may be included in the polyester mixture during the reaction of the diol and the dicarboxylic acid or they may be melt blended with the preformed polyester. A preferred method of including colorants is to use a colorant having thermally stable organic colored compounds having reactive groups such that the colorant is copolymerized and incorporated into the polyester to improve its hue. For example, colorants such as dyes possessing reactive hydroxyl and/or carboxyl groups, including, but not limited to, blue and red substituted anthraquinones, may be copolymerized into the polymer chain. When dyes are employed as colorants, they may be added to the polyester reaction process after an ester interchange or direct esterification reaction.

The polyester blend may also be formed into film or sheet using many methods known to those skilled in the art, including but not limited to extrusion and calendering. In the extrusion process, the polyesters, typically in pellet form, are mixed together in a tumbler and then placed in a hopper of an extruder for melt compounding. Alternatively, the pellets may be added to the hopper of an extruder by various feeders, which meter the pellets in their desired weight ratios. Upon exiting the extruder the now homogenous copolyester blend is shaped into a film. The shape of the film is not restricted in any way. For example, it may be a flat sheet or a tube. The film obtained may be stretched, for example, in a certain direction by from 2 to 6 times the original measurements.

The stretching method for the film may be by any of the methods known in the art, such as, the roll stretching method, the long-gap stretching, the tenter-stretching method, and the tubular stretching method. With the use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also the stretching may be done first in one direction and then in the other direction to result in effective biaxial stretching.

Our invention also includes a process for the manufacture of film or sheet, comprising any of the polyester compositions of the invention. Articles, film, sheet, and/or fibers may be made comprising the compositions of the invention. Also, this invention includes a process for making such articles, film, sheet, and/or fibers comprising the steps of injection molding, extrusion blow molding, film/sheet extruding or calendering the polymer compositions of the invention.

For the purposes of this invention, the abbreviations PETG (for compositions with up to 50 mol % CHDM) and PCTG (for compositions with greater than 50 mol % CHDM) are often used to identify these materials. EG refers ethylene glycol; PD refers to 1,3-propanediol; CHDM refers to 1,4-cyclohexanedimethanol; DMT is dimethyl terephthalate; and T is terephthalic acid.

The present invention is illustrated in greater detail by the specific examples presented below. It is to be understood that these examples are illustrative embodiments and are not intended to be limiting of the invention, but rather are to be construed broadly within the scope and content of the appended claims.

### EXAMPLES

### Example 1

In this example a terephthalic acid, 75 mole percent CHDM, 25 mole percent PD copolyester was prepared. 97.10 grams (0.50 moles) of DMT, 57.32 grams (0.3975 moles) of CHDM, 26.83 grams (0.3525 moles) of PD were added to a 500 ml single neck round bottom flask. The catalyst system consisted of 54 ppm titanium, 55 ppm manganese and 80 ppm phosphorus. Titanium and manganese catalysts were added upfront. The flask was immersed in a Belmont metal bath that was pre-heated to 220° C. Immediately after the flask was immersed the temperature set point was increased to 290° C., and held for 30 minutes. After this time the theoretical amount of methanol was collected. The phosphorus catalyst, in the form of Merpol A, was added. The pressure in the flask was then reduced from atmospheric to 0.3 mm of Hg. Stirring was reduced as the viscosity increased until a stir rate of 15 rpm was obtained. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.863 dL/g The polymer had first cycle melting point of 169.2° C. and 233.6° C. The polymer had a Tg of 79.5° C. and a second cycle melting point of 234.7° C. Compositional analysis (by NMR) showed the copolyester contained 71.7 mole percent CHDM and 28.3 mole percent PD.

### Example 2

Example of an amorphous copolyester. 97.10 grams (0.50 moles) of DMT, 42.03 grams (0.2915 moles) of CHDM, 34.89 grams (0.4585 moles) of PD were added to a 500 ml single neck round bottom flask. The catalyst system consisted of 100 ppm titanium added upfront. The flask was immersed in a Belmont metal bath that was pre-heated to 210° C. Immediately after the flask was immersed the temperature set point was increased to 280° C., and held for 30 minutes. After this time the theoretical amount of methanol was collected. The pressure in the flask was then reduced from atmospheric to 0.3 mm of Hg. Stirring was reduced as the viscosity increased until a stir rate of 15 rpm was obtained. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.895 dL/g. The polymer had a Tg of 68.9° C. and no detectable crystalline melting point on the first or second cycle DSC runs. Compositional analysis (by NMR) showed the copolyester contained 48.8 mol % CHDM and 51.2 mol % PD.

### Example 3

Example of an amorphous copolyester. 97.10 grams (0.50 moles) of DMT, 34.39 grams (0.2385 moles) of CHDM, 38.93 grams (0.5115 moles) of PD were added to a 500 ml single neck round bottom flask. The catalyst system consisted of 100 ppm titanium added upfront. Procedure used for the synthesis was the same as stated in Example 2. The inherent viscosity of the polymer was 0.859 dL/g. The polymer had a Tg of 65.7° C. Compositional analysis (by NMR) showed the copolyester contained 43.3 mol % CHDM and 56.7 mol % PD.

### Example 4

In this example a T, 15CHDM, 85PD composition was prepared. 97.10 grams (0.50 moles) of DMT, 11.46 grams (0.0795 moles) of CHDM, 51.03 grams (0.6705 moles) of PD were added to a 500 ml single neck round bottom flask. The catalyst system consisted of 100 ppm titanium added upfront. Procedure used for the synthesis was the same as stated in Example 2. The inherent viscosity of the polymer was 0.913 dL/g. The polymer had first cycle melting point of 200.9° C. The polymer had a Tg of 54.3° C. and a second cycle melting point of 201.4° C. Compositional analysis (by NMR) showed the copolyester contained 14.7 mol % CHDM and 85.3 mol % PD.

### Example 5

Example of a crystalline copolyester: 97.10 grams (0.50 moles) of DMT, 3.82 grams (0.0265 moles) of CHDM, 55.06 grams (0.7235 moles) of PD were added to a 500 ml single neck round bottom flask. The catalyst system consisted of 100 ppm titanium added upfront. Procedure used for the synthesis was the same as stated in Example 2. The inherent viscosity of the polymer was 0.935 dL/g. The polymer had first cycle melting point of 188.12° C. and 216.5° C. The polymer had a Tg of 52.0° C. and a second cycle melting point of 217.0° C. Compositional analysis (by NMR) showed the copolyester contained 7.0 mol % CHDM and 93.0 mol % PD.

### Example 6

In this example a terephthalic acid, 55 mole percent EG, 45 mole percent PD composition was prepared. 97.10 grams (0.50 moles) of DMT, 43.91 grams (0.7075 moles) of EG, 22.26 grams (0.2925 moles) of PD were added to a 500 ml single neck round bottom flask. The catalyst system consisted of 54 ppm titanium, 55 ppm manganese and 80 ppm phosphorus. Titanium and manganese catalysts were added upfront. The flask was immersed in a Belmont metal bath that was pre-heated to 200° C. Materials were allowed to melt while increasing the stir rate, and held at 200° C. for 1 hour. After the hour at 200° C. the temperature was increased to 210° C., and held for 1.5 hours. After this time the theoretical amount of methanol was collected. The phosphorus catalyst, in the form of Merpol A, was then added and the temperature setpoint was increased to 280° C. The pressure in the flask was then reduced from atmospheric to 0.3 mm of Hg. Stirring was reduced as the viscosity increased until a stir rate of 15 rpm was obtained. The vacuum was discontinued and nitrogen was bled into the flask. The polymer was allowed to solidify by cooling to a temperature below Tg, removed from the flask and ground to pass through a 3 mm screen. The inherent viscosity of the polymer was 0.758 dL/g. The polymer had a Tg of 66.8° C. Compositional analysis (by NMR) showed the copolyester contained 57.5 mol % EG and 42.5 mol % PD.

### Example 7

In this example, a terephthalic acid, 45 mole percent PD, 55 mole percent EG polyester composition was prepared. 29.35 pounds of DMT, 10.32 pounds of EG, and 6.73 pounds of PD were charged into a stainless steel reaction vessel. The catalyst system consisted of 55 ppm titanium, 55 ppm manganese and 20 ppm phosphorous. Titanium and manganese catalysts were added upfront. The agitator speed was set at 25 rpm and reactor was heated to 200° C. and held for 2 hours. The temperature was then increased to 220° C. and held for one hour. The phosphorous catalyst, in the form of Merpol A, was then added and the temperature set point was increased to 270° C. When the temperature reached 240° C., a pressure ramp of 13 mm of Hg/minute to full vacuum was initiated. Reactor conditions were held at 270° C. for 45 minutes. Vaccum was discontinued and the reactor was brought back to atmospheric pressure with nitrogen. Material was immediately extruded and chopped. The inherent viscosity of the polymer was 0.662. The polymer had a Tg of 59.2° C. and no detectable crystalline melting point on the first or second cycle DSC runs. Compositional analysis (by NMR) showed the copolyester contained 54.4 mole percent EG and 45.6 mole percent PD.

### Example 8

In this example, a terephthalic acid, 45 mole percent PD, 55 ethylene glycol was prepared. 29.35 pounds of DMT, 10.32 pounds of EG, and 6.73 pounds of PD were charged into a stainless steel reaction vessel. The catalyst system consisted of 100 ppm titanium added upfront. Procedure used for synthesis was the same as stated in Example 7. Material was immediately extruded and chopped. The inherent viscosity of polymer was 0.688. The polymer has a Tg of 64.5° C. and no detectable crystalline melting point on the first or second cycle DSC runs. Compositional analysis (by NMR) showed the copolyester contained 52.7 mole percent ethylene glycol and 47.3 mole percent PD.

### Example 9

In this example, a terephthalic acid, 75 mole percent PD, 25 mole percent EG composition was prepared. 28.74 pounds of DMT, 4.59 pounds of EG, and 10.98 pounds of PD were charged into a stainless steel reaction vessel. The catalyst system consisted of 55 ppm titanium, 55 ppm manganese and 20 ppm phosphorous. Titanium and manganese catalysts were added upfront. Procedure used for synthesis was the same as stated in Example 7. Material was immediately extruded and chopped. The inherent viscosity of the polymer was 0.68 dL/g. The polymer had a first cycle melting point of 199.97° C. The polymer had a Tg of 52.1° C. and a second cycle melting point of 199.1° C. Compositional analysis (by NMR) showed the copolyester contained 25.1 mole percent EG and 74.9 mole percent PD.

### Example 10

In this example, a terephthalic acid, 45 mole percent PD, and 55 mole % CHDM polyester composition was prepared. 23.91 pounds of DMT, 10.35 pounds of CHDM, and 6.32 pounds of PD were charged into a stainless steel reaction vessel. The catalyst system consisted of 75 ppm titanium added upfront. The agitator speed was set at 25 rpm and reactor was heated to 270° C., a pressure ramp of 13 mm of Hg/minute to full vaccum was initiated.

Reactor conditions were held at 270° C. for 1 hour. Vacuum was discontinued and the reactor was brought back to atmospheric pressure with nitrogen. Material was immediately extruded and chopped. The inherent viscosity of the polymer was 0.714. The polymer had a first cycle melting point of 213.9° C. The polymer had a Tg of 69.6° C. and a second cycle melting point of 216.3° C. Compositional analysis (by NMR) showed the copolyester contained 54.6 mole percent CHDM and 45.4 mole percent PD.

### Example 11

In this example, a terephthalic acid, 55 mole percent PD, 45 mole percent CHDM polyester composition was prepared. 24.60 pounds of DMT, 8.71 pounds of CHDM and 7.95 pounds of PD were charged into a stainless steel reaction vessel. The catalyst system consisted of 75 ppm titanium added upfront. Procedure used for synthesis was the same as stated in Example 10. Material was immediately extruded and chopped. The inherent viscosity of the polymer was 0.738 dL/g. The polymer had a Tg of 67.4° C. and no detectable crystalline melting point on the first or second cycle DSC runs. Compositional analysis (by NMR) showed the copolyester contained 46.7 mole percent CHDM and 53.3 mole PD.

For the purposes of Table I, T(EG)31 (CHDM) contains 100 mole percent of terephthalic acid, 31 mole percent of 1,4-cyclohexanedimethanol, and 68 mole percent of ethylene glycol; T(EG)45(PD) contains 100 mole percent of terephthalic acid, 45 mole percent of 1,3-propanediol, and 55 mole percent of ethylene glycol; T(PD)25(EG) contains 100 mole percent of terephthalic acid, 75 mole percent of 1,3-propanediol, and 25 mole percent of ethylene glycol; T(CHDM)38(EG) contains 100 mole percent of terephthalic acid, 62 mole percent of 1,4-cyclohexanedimethanol, and 38 mole percent of ethylene glycol.

For the purposes of Table 2, T(CHDM)38(EG) and T(EG)31 (CHDM) are as defined for Table 1. T(CHDM)45(PD) contains 100 mole percent of terephthalic acid, 45 mole percent of 1,3-propanediol, and 55 mole percent of 1,4-cyclohexanedimethanol. T(PD)45(CHDM) contains 100 mole percent of terephthalic acid, 55 mole percent of 1,3-propanediol, and 45 mole percent of 1,4-cyclohexanedimethanol.

For the purposes of this invention and the data in the Examples, Heat Deflection Temperature (HDT), at 455 kilopascals (about 66 psi), was determined according to ASTM D648. Notched and Unnotched Izod Impact Strength was determined at 23° C. according to ASTM D256. Flexural Modulus (Flex Modulus) and flexural strength were determined according to ASTM D790. Tensile properties were determined according to ASTM D638; Flex Modulus, D790 Yield Stress, Break Stress and D638 Yield Stress values are given in Mpa; D790 Yield Stress, Break Stress and D638 Yield Stress values are percentages; HDT is given in ° C.; Notched and Unnotched Izod values are given in foot pounds per inch (53 Joules per meter=1 foot pound per inch).

The color of the polymer pellets is determined in a conventional manner using a HunterLab UltraScan Colorimeter manufactured by Hunter Associates Laboratory, Inc., Reston, Va. The instrument is operated using HunterLab Universal Software (version 3.8). Calibration and operation of the instrument is according to the HunterLab User Manual and is largely directed by the Universal Software. To reproduce the results on any colorimeter, run the instrument according to its instructions and use the following testing parameters: D65 Light Source (daylight, 6500°K color temperature), Reflectance Mode, Large Area View, Specular Included, CIE 10° Observer, Outputs are CIE L*, a*, b*. The pellets are placed in a holder that is 25 mm deep by 55 mm wide and high. The holder is black with a window on one side. During testing, the clear side of the holder is held at the reflectance port of the colorimeter as is normally done when testing in reflectance mode. An increase in the positive b* value indicates yellowness, while a decrease in the numerical value of b* indicates a reduction in yellowness. Color measurement and practice are discussed in greater detail in Anni Berger-Schunn in Practical Color Measurement, Wiley, NY pages 39-56 and 91-98 (1994). Preferably, the b* value is less than +4, more preferably from about +1 to about +2.

TABLE 1
Tx(PD)y(EG) Mechanical Properties

| | | | Example 8 | | |
|---|---|---|---|---|---|
| | | | T55(EG)45(PD) | | |
| | PETG 6763 | Example 7 | (100 ppm Ti | Example 9 | PCTG 5445 |
| | T(79(EG)31(CHDM) | T55(EG)45(PD) | only) | T75(PD)25(EG) | T62(CHDM)38(EG) |
| IV (before | — | 0.693 | 0.688 | 0.679 | — |
| molding) | | | | | |
| IV (after | 0.710 | 0.662 | 0.674 | 0.659 | 0.723 |
| molding) | | | | | |
| Color (L*, | 90.93, −1.3, 1.19 | 59.41, 4.54, 24.73 | 56.04, 6.07, 24.32 | 58.60, 3.48, 23.11 | — |
| a*, b*) | | | | | |
| Tg (° C.) | 82° C. | 59° C. | 62° C. | 52° C. | 87° C. |
| HDT | | | | | |
| 66 psi | 69° C. | 53° C. | 55° C. | 51° C. | 75° C. |
| 264 psi | 63° C. | 53° C. | 53° C. | 49° C. | 67° C. |
| Tensile | | | | | |
| Yield Stress | 7,149 | 8,297 | 8,226 | 8,124 | 6,381 |
| psi | | | | | |
| Yield Strain % | 4.96 | 4.62 | 4.72 | 4.38 | 5.36 |
| Break Stress | 3,759 | 7,383 | 6,743 | 5,384 | 6,240 |
| psi | | | | | |
| Break Strain % | 122.8 | 4.90 | 7.30 | 5.76 | 276.6 |
| Flex | | | | | |
| Yield Strain % | 5.09 | 4.31 | 4.37 | 4.05 | 5.55 |
| Yield Stress | 9,922 | 10,428 | 10,570 | 9,754 | 8,983 |
| psi | | | | | |
| Modulus psi | 297,399 | 334,387 | 336,701 | 328,586 | 249,578 |
| Izod | | | | | |
| Notched - | 100% Break (1.18) | 100% Break (0.68) | 100% Break (0.75) | 100% Break (0.92) | 100% Break (1.66) |
| −40° C. (ftlb/in) | | | | | |
| Notched 0° C. | 100% Break (1.49) | 100% Break (1.04) | 100% Break (1.18) | 100% Break (1.26) | 80% Break (5.16) |
| (ftlb/in) | | | | | 20% No Break |
| Notched 23° C. | 40% Break (10.45) | 100% Break (0.96) | 100% Break (1.15) | 100% Break (1.12) | 100% No Break |
| (ftlb/in) | 60% No Break | | | | |
| Unnotched - | 100% No Break | 100% No Break | 80% No Break | 100% No Break | 100% No Break |
| −40° C. (ftlb/in) | | | | | |
| Unnotched | 100% No Break | 100% No Break | 100% No Break | 100% No Break | 100% No Break |
| 0° C. (ftlb/in) | | | | | |
| Unnotched | 100% No Break | 100% No Break | 100% No Break | 20% Break (30.61) | 100% No Break |
| 23° C. (ftlb/in) | | | | 20% Hinge | |
| | | | | 60% No Break | |
| Instrumented | | | | | |
| Impact | | | | | |
| Fracture | 39.14 | 24.46 | 29.50 | 18.58 | 40.08 |
| Energy (ftlb) | | | | | |

TABLE 2
Tx(PD)y(CHDM) Mechanical Properties

| | PCTG 5445 | Example 10 | Example 11 | PETG 6763 |
|---|---|---|---|---|
| | T62(CHDM)38(EG) | T55(CHDM)45(PD) | T55(PD)45(CHDM) | T69(EG)31(CHDM) |
| IV (before | 0.718 | 0.719 | 0.731 | 0.735 |
| molding) | | | | |
| IV (after | 0.700 | 0.709 | 0.703 | 0.720 |
| molding) | | | | |
| Color (L*, | — | 66.60, −0.28, 8.49 | 64.94, −0.07, 8.63 | 90.93, −1.3, 1.19 |
| a*, b*) | | | | |
| Tg (° C.) | 87° C. | 70° C. | 67° C. | 82° C. |
| HDT | | | | |
| 66 psi | 74° C. | 60° C. | 59° C. | 71° C. |
| 264 psi | 65° C. | 56° C. | 55° C. | 64° C. |
| Tensile | | | | |
| Yield Stress | 6,506 | 6,583 | 6,707 | 7,229 |
| psi | | | | |
| Yield Strain % | 5.38 | 5.00 | 5.10 | 5.14 |
| Break Stress | 6,228 | 4,887 | 3,554 | 3,768 |
| psi | | | | |
| Break Strain % | 262.0 | 214.5 | 108.8 | 99.1 |
| Flex | | | | |
| Yield Strain % | 5.76 | 4.98 | 4.90 | 5.40 |
| Yield Stress | 8,952 | 8,456 | 8,500 | 9,569 |
| psi | | | | |
| Modulus psi | 247,547 | 243,317 | 244,165 | 272,389 |
| Izod | | | | |
| Notched - | 100% Break (0.99) | 100% Break (1.43) | 100% Break (1.42) | 100% Break (0.51) |
| −40° C. | | | | |
| (ftlb/in) | | | | |
| Notched 0° C. | 100% Break (1.74) | 100% No Break | 20% Break (25.63) | 100% Break (1.52) |
| (ftlb/in) | | | 80% No Break | |
| Notched | 100% No Break | 100% No Break | 100% No Break | 80% Break (6.27) |
| 23° C. | | | | 20% No Break |
| (ftlb/in) | | | | |
| Unnotched - | 100% No Break | 20% Break (47.05) | 100% No Break | 100% No Break |
| −40° C. | | 80% No Break | | |
| (ftlb/in) | | | | |
| Unnotched | 100% No Break | 100% No Break | 100% No Break | 100% No Break |
| 0° C. (ftlb/in) | | | | |
| Unnotched | 100% No Break | 100% No Break | 100% No Break | 100% No Break |
| 23° C. | | | | |
| (ftlb/in) | | | | |
| Instrumented | | | | |
| Impact | | | | |
| Fracture | 35.91 | 35.28 | 36.00 | 35.87 |
| Energy (ftlb) | | | | |

The invention has been described in detail with particular reference to preferred embodiments thereof, but it will be understood that variations and modifications can be effected within the spirit and scope of the invention.

We claim:

1. A polyester composition comprising:
(i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid; and
(ii) diol residues comprising from about 25 to about 70 mole percent, based on the total moles of diol residues, of the residues of 1,4-cyclohexanedimethanol, and from about 75 to about 30 mole percent, based on the total moles of diol residues, of the residues of 1,3-propanediol.

2. A polyester composition comprising:
(i) diacid residues comprising at least 80 mole percent, based on the total moles of diacid residues, of the residues of terephthalic acid; and
(ii) diol residues comprising about 30 to about 70 mole percent, based on the total moles of diol residues, of the residues of 1,4-cyclohexanedimethanol, and from about 70 to about 30 mole percent, based on the total moles of diol residues, of the residues of 1,3-propanediol.

3. A polyester composition according to claims 1 or 2 comprising:
(i) diacid residues comprising at least 80 mole percent, based on the total moles of diacid residues, of the residues of terephthalic acid; and
(ii) diol residues comprising about 40 to about 60 mole percent, based on the total moles of diol residues, of the residues of 1,4-cyclohexanedimethanol, and from about to about 40 mole percent, based on the total moles of diol residues, of the residues of 1,3-propanediol.

4. The polyester composition of claim 3 comprising:
(i) diacid residues comprising at least 90 mole percent, based on the total moles of aromatic diacid residues comprising terephthalic acid, naphthalenedicarboxylic acid, and isophthalic acid; and
(ii) diol residues comprising from about 45 to about 55 mole percent, based on the total moles of diol residues, of the residues of 1,4-cyclohexanedimethanol, and from about 55 to about 45 mole percent, based on the total moles of diol residues, of the residues of 1,3-propanediol.

5. The polyester composition of claim 4 comprising:
(i) diacid residues comprising at least 90 mole percent, based on the total moles of diacid residues, of the residues of: terephthalic acid; and
(ii) diol residues comprising from about 45 to about 55 mole percent, based on the total moles of diol residues, of the residues of 1,4-cyclohexanedimethanol, and from about 55 to about 45 mole percent, based on the total moles of diol residues, of the residues of 1,3-propanediol.

6. The polyester composition of claims 1, 2 or 3 wherein said diol residues comprise 0 to 60 mole percent of one or more diols selected from ethylene glycol, 1,2-propanediol, 1,4-butanediol, 1,5-pentanediol, neopentyl glycol, diethylene glycol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol.

7. The polyester composition of claims 6 wherein said diol residues comprise ethylene glycol.

8. The polyester composition of claims 1 or 3 wherein said diol residues comprise 0.1 to 45 mole percent residues of ethylene glycol.

9. The polyester composition of claims 1, 2 or 3 containing one or more branching agents comprising about 0.01 to about 10.0 weight percent, based on the total weight of the polyester.

10. The polyester composition of claim 9 containing one or more branching agents comprising about 0.05 to about 5 weight percent, based on the total weight of the polyester.

11. The polyester composition of claim 10 wherein said branching monomer residues comprise about 0.01 to about 1 weight percent (wt %), based on the total weight of said polyester, of one or more residues of monomers having 3 or more carboxyl substituents, hydroxyl substituents, or a combination thereof.

12. The polyester composition of claim 11 wherein said branching monomer residues comprise about 0.1 to about 0.7 mole percent of one or more residues of: trimellitic anhydride, pyromellitic dianhydride, glycerol, sorbitol, 1,2,6-hexanetriol, pentaerythritol, trimethylolethane, or trimesic acid.

13. The polyester composition of claims 1, 2 or 3 comprising one or more plasticizers.

14. The polyester composition of claim 1, 2 or 3 comprising about 5 to about 40 wt %, based on the total weight of said polyester composition, of a flame retardant.

15. The polyester composition of claim 14 comprising one or flame retardants selected from the group consisting of phosphorus based compounds.

16. The polyester composition of claim 15 comprising one or more monoesters, diesters, or triesters of phosphoric acid.

17. The polyester composition of claims 1 or 2 wherein said polyester is amorphous.

18. The polyester composition of claims 1, 2 or 3 wherein said polyester has an inherent viscosity of 0.4 to 1.4 dL/g.

19. The polyester composition of claims 1, 2 or 3 wherein said polyester has an impact strength of notched Izod values of 15 ft-lb per inch at 0° as measured by ASTM Method 256 using ⅛ inch molded bars.

20. A process for the manufacture of film or sheet, comprising the steps of extruding or calendering a polyester composition comprising:
(i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid; and
(ii) diol residues comprising from about 25 to about 70 mole percent, based on the total moles of diol residues, of the residues of 1,4-cyclohexanedimethanol, and from about 75 to about 30 mole percent, based on the total moles of diol residues, of the residues of 1,3-propanediol.

21. A film or sheet comprising a polyester composition further comprising:
(i) diacid residues comprising at least 80 mole percent, based on the total moles of diacid residues, of one or more residues of: terephthalic acid, naphthalenedicarboxylic acid, 1,4-cyclohexanedicarboxylic acid, or isophthalic acid; and
(ii) diol residues comprising from about 30 to about 70 mole percent, based on the total moles of diol residues, of the residues of 1,4-cyclohexanedimethanol, and from 70 to about 30 mole percent, based on the total moles of diol residues, of the residues of 1,3-propanediol.

22. A film or sheet comprising a polyester composition further comprising:
(i) diacid residues comprising at least 80 mole percent, based on the total moles of diacid residues, of the residues of terephthalic acid; and
(ii) diol residues comprising from about 40 to about 60 mole percent, based on the total moles of diol residues, of the residues of 1,4-cyclohexanedimethanol, and from about 60 to about 40 mole percent, based on the total moles of diol residues, of the residues of 1,3-propanediol.

23. The film or sheet of claims 21 or 22 comprising:
(i) diacid residues comprising at least 90 mole percent, based on the total moles of aromatic diacid residues comprising terephthalic acid, naphthalenedicarboxylic acid, and isophthalic acid; and
(ii) diol residues comprising from about 45 to about 55 mole percent, based on the total moles of diol residues, of the residues of 1,4-cyclohexanedimethanol, and from about 55 to about 45 mole percent, based on the total moles of diol residues, of the residues of 1,3-propanediol.

24. The film or sheet of claim 23 comprising:
(i) diacid residues comprising at least 90 mole percent, based on the total moles of diacid residues, of the residues of: terephthalic acid; and
(ii) diol residues comprising from about 45 to about 55 mole percent, based on the total moles of diol residues, of the residues of 1,4-cyclohexanedimethanol, and from about 55 to about 45 mole percent, based on the total moles of diol residues, of the residues of 1,3-propanediol.

25. The film or sheet of claims 21 or 22 wherein said diol residues comprise 0 to 45 mole percent of one or more diols selected from ethylene glycol, 1,2-propanediol, 1,4-butanediol, 1,5-pentanediol, neopentyl glycol, diethylene glycol, 1,6-hexanediol, 1,8-octanediol, 2,2,4-trimethyl-1,3-pentanediol, 2,2,4,4-tetramethyl-1,3-cyclobutanediol, 1,3-cyclohexanedimethanol, bisphenol A, and polyalkylene glycol.

26. The film or sheet of claim 25 wherein said diol residues comprise ethylene glycol.

27. The film or sheet of claim 26 wherein said diol residues comprise about 0.1 to 45 mole percent ethylene glycol.

28. The film or sheet comprising the polyester composition of claims 21 or 22 further comprising one or more branching agents comprising about 0.01 to about 10.0 weight percent, based on the total weight of the polyester.
